(19) United States
(12) Patent Application Publication
(10) Pub. No.: US 2010/0042781 A1
(43) Pub. Date: Feb. 18, 2010

(54) Headset with integral non-volatile flash memory drive

(75) Inventor: Edward L Reuss, Santa Cruz, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: Plantronics, Inc.

(21) Appl. No.: 11/786,497

(22) Filed: Apr. 12, 2007

(51) Int. Cl. G06F 12/00; G06F 13/12

(52) U.S. Cl. 711/115; 710/63; 711/E12.001

(57) ABSTRACT

A headset flash memory drive that includes a flash memory chip for data storage and a digital data interface. The headset flash memory drive further includes a computer readable memory storing first instructions for a mass storage access protocol that when executed by a headset controller allow data transfer to and from the flash memory chip through the digital data interface, and storing second instructions that when executed by the controller allow the microphone to detect user speech or the speaker to output an audio signal.

### BACKGROUND OF THE INVENTION

Recent developments in the electronics industry have produced inexpensive processors that have low power requirements, as well as flash memory chips that also have low power requirements. These developments allow for the development of extremely sophisticated intelligent headsets that can perform a variety of tasks related to the headset function.

While these headset function related tasks utilize increasing quantities of non-volatile memory, the memory requirements for even very advanced headset features remains a small fraction of the size of the non-volatile flash memories that are becoming commonplace and inexpensive. At the same time the interfaces to the host device or telecommunications network have switched from analog audio telephony interfaces to digital interfaces, many of which offer converged voice and data services. These digital interfaces include, but are not limited to Universal Serial Bus (USB), Bluetooth (BT) and IEEE 802.11.

One of the data services provided on these interfaces is the ability to communicate with a mass storage memory device. USB-based flash-memory storage devices or “flash memory drives” have been developed to easily and conveniently transport data from one host to another. While large external flash drives may be used, smaller USB flash memory drives are frequently used and are growing in use. A typical flash memory drive has a housing including an integral connector for connecting to a USB port on a computer or other device. When plugged into a USB port, the computer operating system recognizes the flash memory device as a removable drive and allows data to be retrieved from or written to the flash memory drive.

However, in the prior art these USB flash drives have been distinct devices from headsets. Thus, if the user wanted to use a flash memory drive in addition to a headset, the only solution was to carry both the headset and a separate flash memory device, taking up more space in the user's pocket and increasing the likelihood that either the flash memory drive or headset will get lost.

As a result, there is a need for improved methods and apparatuses for headsets and flash memory drives.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a simplified block diagram of a headset in one example of the invention.

FIG. 2 illustrates a simplified block diagram of a headset in one example of the invention.

FIG. 3 illustrates a simplified block diagram of a headset in one example of the invention.

FIG. 4 illustrates a simplified block diagram of a headset in one example of the invention.

FIGS. 5A-5C illustrates a front, back and side view of a headset body in one example of the invention.

FIG. 6 illustrates a mini-AB receptacle connector.

FIG. 7 illustrates an example use of the headset shown in FIG. 2 and FIGS. 5A-5C.

FIG. 8 illustrates a simplified block diagram of a headset with multiple digital interfaces in one example of the invention.

### DESCRIPTION OF SPECIFIC EMBODIMENTS

Methods and apparatuses for headsets with integral non-volatile flash memory drives are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

The invention relates to the general field of intelligent headsets and specifically to headsets with a computer compatible interface. This description describes a method and apparatus for headset with a flash memory drive and a digital interface such as USB, Bluetooth or IEEE 802.11. The software or firmware in the headset is augmented by adding code that permits the user to access the flash memory via one of the standard mass storage access protocols available for that interface, such as a USB mass storage device as used on a USB flash drive. Thus, the headset may switch between operation as a general telecommunications headset to receive and transmit voice signals and operation as a flash memory drive for downloading or uploading data.

In one example, methods and systems are presented which permit a user that is carrying a headset to also use the headset as a flash memory drive whenever there is a need to copy a particular file or files, thereby reducing the number of devices in the user's pocket and also reducing the likelihood that one or the other will get misplaced. In one example, a flash memory drive is added to any headset that incorporates a USB charging interface or any headset with a wireless interface that can support a mass storage profile, such as Bluetooth or IEEE 802.11.

In one example of the invention, a headset flash memory drive includes a headset housing, a microphone, a speaker, a flash memory chip for data storage, a mini USB AB type connector, a wireless digital data interface, and a controller. The headset flash memory drive further includes a computer readable memory storing first instructions for a USB mass storage device class communications protocol that when executed by the controller allow data transfer to or from the flash memory chip through the mini USB AB type connector, and storing second instructions that when executed by the controller allow voice communications to be transmitted or received through the wireless digital data interface.

In one example of the invention, a headset flash memory drive includes a headset housing, a microphone, a speaker, a flash memory chip for data storage, a wired digital data interface connector, and a controller. The headset flash memory drive further includes a computer readable memory storing first instructions for a mass storage access protocol that when executed by the controller allow data transfer to and from the flash memory chip through the wired digital data interface connector, and storing second instructions that when executed by the controller allow the microphone to detect user speech or the speaker to output an audio signal.

In one example of the invention, a headset flash memory drive includes a headset housing, a microphone, a speaker, a flash memory chip for data storage, a wireless digital data interface, and a controller. The headset flash memory drive further includes a computer readable memory storing first instructions for a mass storage access protocol that when executed by the controller allow data transfer to and from the flash memory chip through the wireless digital data interface, and storing second instructions that when executed by the controller allow the microphone to detect user speech or the speaker to output an audio signal.

In one example of the invention, a headset flash memory drive includes a headset housing, a microphone, a speaker, a rechargeable battery, a controller, a flash memory for mass data storage, and a wired digital interface connector for transferring data to or from the flash memory, transferring audio communications to the speaker or from the microphone, or transferring charging power to the rechargeable battery. The headset flash memory drive further includes a wireless digital data interface for transferring data to or from the flash memory, or transferring audio communications to the speaker or from the microphone. The headset flash memory drive further includes a computer readable memory storing first instructions that when executed by the controller allow data transfer to or from the flash memory means through either the wired digital interface connector or the wireless digital data interface, and storing second instructions that when executed by the controller allow voice communications to be transmitted or received through the wired digital interface connector or the wireless digital data interface.

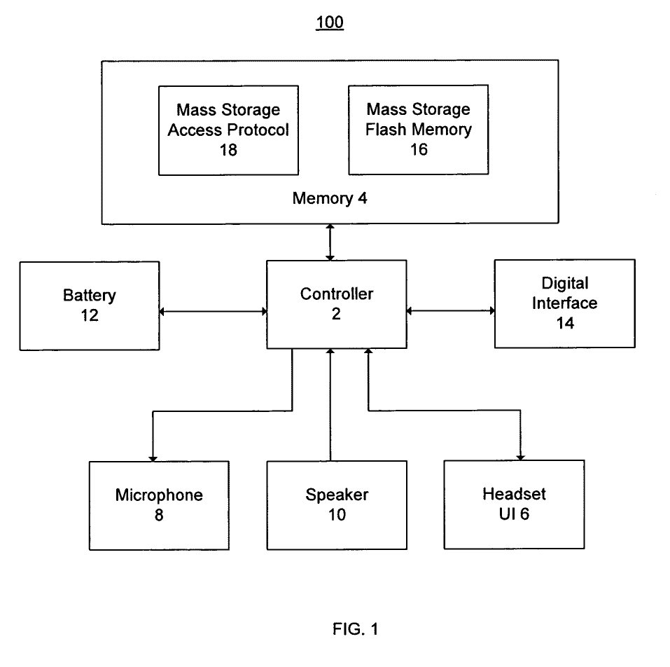

FIG. 1 illustrates a simplified block diagram of the components of a headset in an example of the invention. Headset flash memory drive 100 may include a controller 2 which utilizes a processor, memory 4, and software or firmware to implement functionality as described herein. The controller 2 receives input from headset user interface 6 and manages audio data received from microphone 8 and sent to speaker 10. Controller 2 controls the overall operation of the headset flash memory drive 100. The controller 2 further interacts with digital interface 14 to transmit and receive data to and from the headset flash memory drive 100. In a further example, the digital interface 14 may include a controller which controls one or more operations of the headset flash memory drive 100.

Battery 12 provides power to the various components of the headset. For example, battery 12 is a rechargeable battery such as a lithium ion battery, which is used to provide a regulated voltage supply at various levels as needed by the components. A charging circuit is used to provide charging power to battery 12.

Controller 2 receives input from various user interface components including, for example, a call initiate, answer, and terminate button, a volume encoder, a mute circuit/switch, and an on/off circuit. Controller 2 also has input/output interfaces including, for example visual indicators. The headset user interface includes a means to be alerted of an incoming call and a means to answer the call.

Microphone 8 detects the user's speech, and the analog signals formed are converted by an A/D converter before the speech is encoded by an audio codec unit. A D/A converter converts digital audio for playback over speaker 10. Controller 2 forms the interface to the user interface 6 and memory 4, which includes RAM and ROM. For example, memory 4 may include a combination of non-volatile and volatile memory, including flash memory and SDRAM. In the present example, memory 4 includes a mass storage flash memory 16. For example, mass storage flash memory 16 may be a separate NAND flash memory chip dedicated to mass storage. In one example, the total amount of flash memory storage capacity may be, but is not limited to 256 MB, 512 MB, 1 gigabyte, 2 gigabytes, or other amounts of memory. One of ordinary skill in the art will recognize that the size of mass storage flash memory 16 may increase as greater sized flash memory chips are fabricated, or that the amount of memory storage may be chosen for a specific application. Memory 4 also includes a mass storage access protocol firmware application 18 which when executed by controller 2 controls writing and reading of data to and from mass storage flash memory 16.

Controller 2 contains a flash-memory controller that generates signals to access memory locations within mass storage flash memory 16. The controller 2 is connected to the user interface 6 and monitors the activity in the headset and controls the audio output in response thereto. Controller 2 receives user actions from headset user interface 6 and detects the occurrence of a state change event and changes the state or settings of the headset. A state change event may be caused by the user when he or she initiates an action on the user interface 6 or other type of user input means. Alternatively, a state change event may occur automatically, as in the example of an incoming call. Digital interface 14 may use any variety of wired or wireless communication technologies to transfer data to and from mass storage flash memory 16 at headset flash memory drive 100, thereby allowing headset flash memory drive 100 to be used as a flash memory drive. Digital interface 14 may also operate to transfer voice communications to and from headset flash memory drive 100.

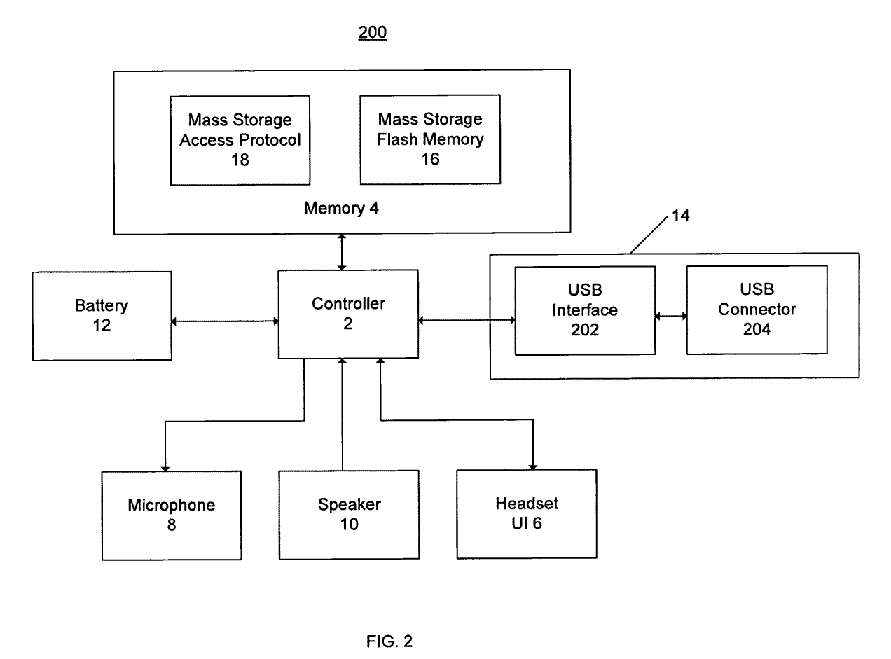

FIG. 2 illustrates a simplified block diagram of the components of a headset flash memory drive 200 in which the digital interface 14 of headset flash memory drive 100 shown in FIG. 1 is a USB interface 202 having a USB connector 204. Universal-Serial-Bus (USB) has become a popular standard interface for connecting peripherals to a personal computer (PC) or other host electronic devices. USB interface 202 is configured to operate in accordance with the USB transfer protocol. In this example, USB connector 204 is a mini USB AB type receptacle (female) connector (also referred to as mini-AB), having a flat and narrow shape capable of receiving either a mini A or mini B connector plug. In a further example, USB connector 204 is a mini A or mini B connector plug. The USB interface 202 and USB connector 204 may also be replaced with a wireless USB interface transceiver operating in accordance with the Wireless USB (WUSB) standard.

The use of a mini USB AB type receptacle in headset flash memory drive 200 is particularly advantageous since it has a smaller form factor suitable for the limited housing size of a headset. Mini-USB plugs, sockets and cables were introduced in Universal Serial Bus On-The-Go (USB OTG), a supplement to USB 2.0. The USB OTG specification allows a single port to act as either a host or a device. The USB OTG specification defines a Mini-A plug, a Mini-B plug, and a Mini-AB receptacle which can receive either the Mini-A plug or the Mini-B plug. The plugs and sockets have 5 contacts, where the Mini-A plug has contacts 4 and 5 joined together inside the Mini-A plug. Both the Mini-A plug and Mini-B plug are rectangular in shape, with the contact opening measuring approximately 6.8 (W)×3.1 (H) mm.

In one example manner of operation, headset flash memory drive 200 is automatically operated in a flash memory drive mode when USB connector 204 is coupled to an appropriate USB connector and operates in flash memory drive mode to store or transmit data. In this configuration, a charging circuit may also charge the battery 12 via the USB connector 204. Controller 2 contains a USB interface mass storage controller that serially transfers data packets to and from mass storage flash memory 16 over the USB connection. The USB interface controller decodes commands and addresses in the USB packets and performs requested operations.

In this configuration, the headset flash memory drive 200 implements the USB mass storage device class (also referred to as mass storage class (MSC) or UMS (USB Mass storage)) communications protocols. The USB Mass Storage device class specification is hereby incorporated by reference in its entirety.

In further examples, USB connector 204 may take the form of other types of USB connectors other than mini-type. For example, USB connector 204 may be an A-type or B-type connector as defined by the USB specification. The A-type USB interface has a flat and wide shape, while the B-type USB interface has a rectangular shape. Furthermore, USB connector 204 may take the form of a plug (male) or receptacle (female) USB connector, regardless of the USB architecture. In a further example, the digital interface 14 is an Ethernet or firewire connector.

In a further example, data may be uploaded or downloaded from the mass storage flash memory 16 using a wireless system such as IEEE 802.11 or Bluetooth to create a short range, wireless “personal area network” to communicate with other electronic devices within the wireless system having the same type of transceiver. The data may include, for example, audio data, video data, text data, or any combination thereof.

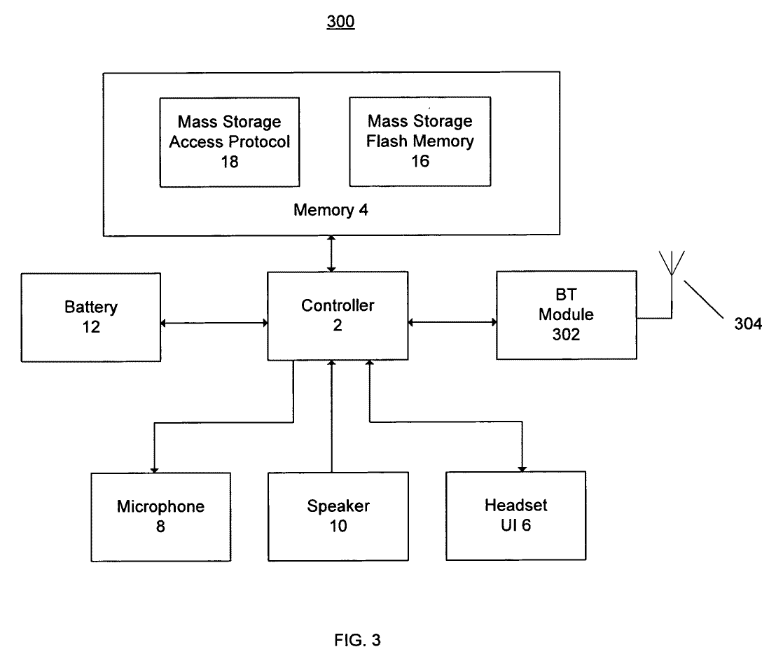

FIG. 3 illustrates a simplified block diagram of the components of a headset flash memory drive 300 in which the digital interface 14 of headset flash memory drive 100 shown in FIG. 1 is a Bluetooth module 302 coupled to an antenna 304. Antenna 304 may be in a form integral with the Bluetooth module 302 or an antenna external to the Bluetooth module 302 transceiver. Bluetooth module 302 enables the headset flash memory drive 300 to communicate with other Bluetooth devices in accordance with the Bluetooth protocol. In further examples, digital interface 14 may be any digital wireless transceiver. In one example, headset flash memory drive 300 communicates over a personal area network (PAN) via the wireless link established by Bluetooth module 302. The Bluetooth module 302 communicates over an RF network employing the Bluetooth standard with corresponding Bluetooth modules at a host device. The Bluetooth specification, version 2.0, including all of its profiles and protocols, is hereby incorporated by reference.

A prescribed interface such as Host Control Interface (HCI) is defined between each Bluetooth module. Message packets associated with the HCI are communicated between the Bluetooth modules. The Bluetooth modules transmit and receive a control command, a response thereto, and user data by exchanging message packets through a host control interface (HCI) defined between the Bluetooth modules. Control commands, result information of the control commands, user data information, and other information are also communicated between Bluetooth modules. The HCI packet is classified into a command packet, an event packet and a data packet.

When headset flash memory drive 300 is operated as a flash memory drive, Bluetooth module switches from a headset signal processing mode to a flash memory drive signal processing mode, whereby the Bluetooth module is configured to support a mass storage access profile mode. In one example, the Bluetooth module is configured to support the Bluetooth file transfer protocol (FTP) profile. The Bluetooth module is configured to transmit data stored on mass storage flash memory 16 to another device such as, for example, a personal computer, a palmtop computer, a laptop computer, or a cell phone. Alternatively, the Bluetooth module may receive data from such example devices and store the data on mass storage flash memory 16.

When operated in a telecommunications headset mode using the Bluetooth headset profile, the Bluetooth module is configured to receive a signal from another Bluetooth transmitter and provide audio output to the headset speaker 10 or to transmit an audio signal received at microphone 8 to another audio device. For example, the Bluetooth headset transmits an audio signal to a cellular telephone to be transmitted by the cellular phone as the speaker's voice over a cellular telephone network, or the Bluetooth headset receives an audio signal from a cellular phone representing a far end speaker's voice.

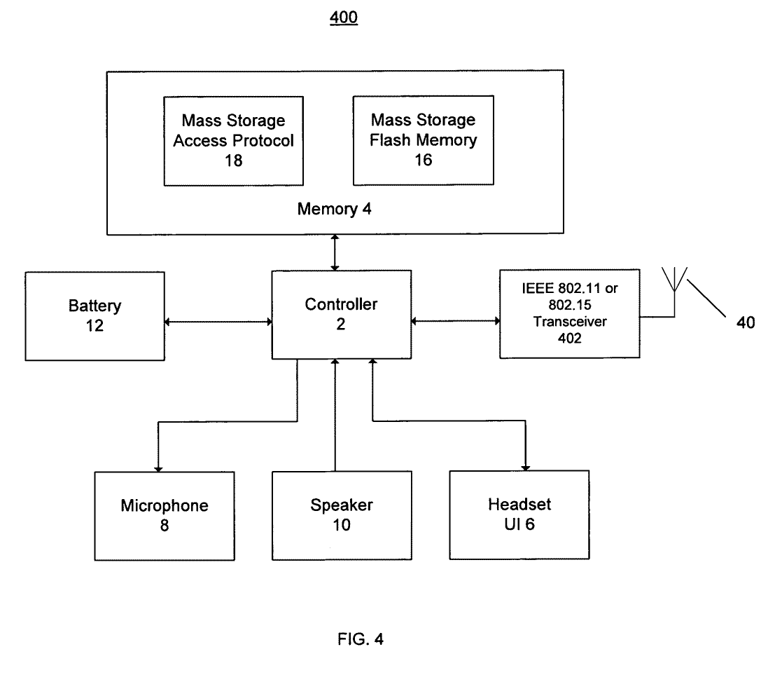

FIG. 4 illustrates a simplified block diagram of the components of a headset flash memory drive 400 in which the digital interface 14 of headset flash memory drive 100 shown in FIG. 1 is an IEEE 802.11 or 802.15 transceiver 402 coupled to an antenna 404. In one example, headset flash memory drive 400 communicates over a local area network (LAN), or a personal area network (PAN) via the wireless link established by the IEEE 802.11 or 802.15 transceiver 402. The transceiver 402 communicates over an RF network employing an IEEE 802.11 or 802.15 standard with corresponding IEEE 802.11 or 802.15 transceivers at a host device. One of ordinary skill in the art will recognize that similar Bluetooth profiles and protocols to those described above can be used on top of the IEEE 802.11 MAC and PHY protocols to implement mass data transfer.

Headset flash memory drive 400 and an IEEE 802.11 or 802.15 access point communicate over an IEEE 802.11 or 802.15 wireless link. The use of the term IEEE 802.11 or 802.15 herein is meant to address the entire family of IEEE 802.11 or 802.15 standards, including IEEE 802.11b, IEEE 802.11g, IEEE 802.11n, and any future standards. In one example, the access point connects to an Ethernet LAN via an Ethernet switch.

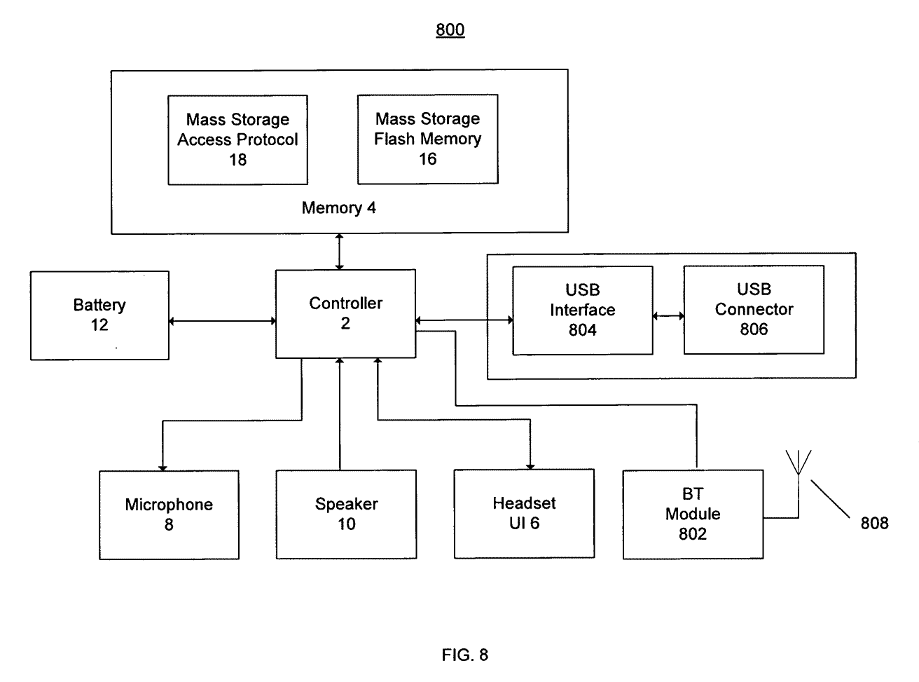

Those skilled in the art will appreciate that various digital interfaces 14 may be used, or that digital interface 14 may actually be two or more digital interfaces of any combination in additional examples while remaining within the scope of the present invention. For example, referring to FIG. 8, a headset 800 may include both a Bluetooth module interface 802 having an antenna 808 and a USB interface 804 and USB connector 806. In this example, the headset 808 may store data received from an electronic device using a wireless Bluetooth connection and the data may be transferred from the headset via the USB type interface, or vice versa. In a further example, Bluetooth module interface 802 may be used primarily for voice communications while USB interface 804 is used for data transfer and storage.

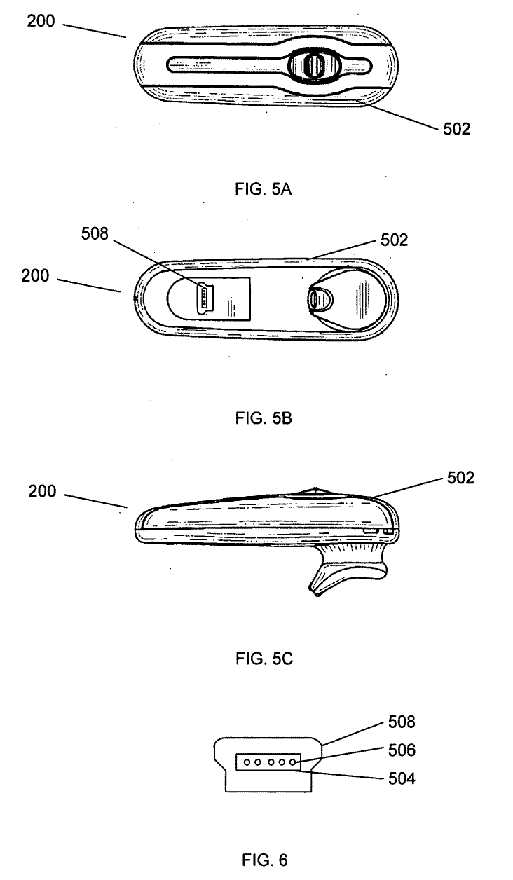

FIGS. 5A, 5B, and 5C are a front elevational view, rear elevational view, and right side elevational view, respectively, of an example headset flash memory drive 200 whose internal circuits are described above in reference to FIG. 2. Referring to FIG. 5B, headset flash memory drive 200 includes a USB connector in the form of a USB mini-AB receptacle connector 508 on the rear side of headset flash memory drive 200. It is understood that the general style of headset flash memory drive 200 shown in FIGS. 5A-5C may take a variety of shapes and forms typical to telecommunications or audio headsets other than that shown in FIG. 5. Headset flash memory drive 200 includes a housing 502 configured to receive a printed circuit board having the electronic components illustrated in the block diagram shown in FIG. 2. The housing 502 includes a physical opening generally rectangular in shape for access to mini-AB receptacle connector 508 electrically coupled to and mounted on the printed circuit board. When the printed circuit board is inserted into the headset housing 502, the mini-AB receptacle connector 508 is aligned with the housing aperture. In a further example, a door may be configured to open and close to expose or hide the mini-AB receptacle connector. Headset flash memory drive 200 may include an LED to indicate by being lit when the headset flash memory drive 200 is operating as a flash memory device and to indicate by flashing when data is being written to or read from the mass storage flash memory of headset flash memory drive 200. The use of headset flash memory drive 200 as a flash memory drive advantageously allows the headset to perform a dual use, thereby eliminating the need for a separate flash memory drive.

FIG. 6 illustrates the mini-AB receptacle connector 508 shown in FIG. 5B. Mini-AB receptacle connector 508 contains a small connector substrate 504 and has an interior plastic color of grey. Connector substrate 504 has 5 metal contacts 506 formed thereon for connecting with contacts on a mini-A or mini-B plug.

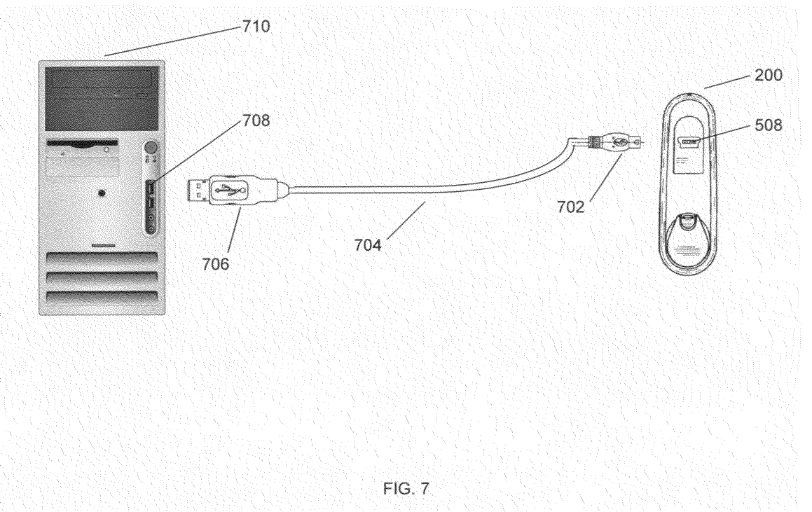

FIG. 7 illustrates an example use of headset flash memory drive 200 shown in FIGS. 2 and 5A-5C. In FIG. 7, headset flash memory drive 200 is connected at mini-AB receptacle connector 508 to a mini-A USB plug connector 702 of a first end of a cable 704. The opposite end of cable 704 is a standard 4-pin USB Series “A” plug connector 706, which is connected to a conventional USB port 708 on a personal computer 710. Referring to FIGS. 2 and 7, in this manner, data stored on mass storage flash memory 16 may be offloaded from the headset flash memory drive 200 to personal computer 710, or alternatively, data may be transferred from personal computer 710 to mass storage flash memory 16 on headset flash memory drive 200 for easy mobile transport. When USB Series “A” plug connector 706 is engaged with the USB port 708 on the personal computer 710, the operating system of personal computer 710 will recognize the headset flash memory drive 200 as a removable drive and allow data to be written to and retrieved from the flash memory storage located in the headset flash memory drive 200.

Using cable 704, headset flash memory drive 200 may be connected to the USB port such as a USB host controller of any common personal computer or other device with a USB port. Personal computer 710 may execute mass storage class software to schedule USB transactions with headset flash memory drive 200. Personal computer 710 can send USB packets requesting to read data on mass storage flash memory 16. Referring again to FIG. 2, the controller 2 on headset flash memory drive 200 acting as a USB peripheral controller activates the USB interface 202 to read data from mass storage flash memory 16.

As described earlier, the mini-AB receptacle connector 508 may be replaced in further examples with other types of USB connectors other than mini-type. For example, USB connector 204 may be an A-type or B-type connector as defined by the USB specification. The A-type USB interface has a flat and wide shape, while the B-type USB interface has a rectangular shape. Furthermore, USB connector 204 may take the form of a plug (male) or receptacle (female) USB connector, regardless of the USB architecture. The connector at first end of cable 704 is selected to mate with the particular USB connector selected. Similarly, the opposite end of cable 704 may be selected to be any of the potential types of USB interfaces to connect to personal computer 710 or other electronic device, such as a printer, scanner, CD/DVD drive, PDA, cell phone, or MP3 player.

The various examples described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. Such changes may include, but are not necessarily limited to: number, placement, and functions performed by the user interface on the headset; wireless communication technologies; headset form factor; flash memory type. Furthermore, the functionality associated with any blocks described above may be centralized or distributed. It is also understood that one or more blocks of the headset may be performed by hardware, firmware or software, or some combinations thereof. Such modifications and changes do not depart from the true spirit and scope of the present invention that is set forth in the following claims.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

1. A headset flash memory drive comprising:
a headset housing;
a microphone;
a speaker;
a flash memory chip for mass data storage;
a mini USB AB type connector;
a wireless digital data interface;
a controller; and
a computer readable memory storing first instructions for a USB mass storage device class communications protocol that when executed by the controller allow data transfer to or from the flash memory chip through the mini USB AB type connector, and storing second instructions that when executed by the controller allow voice communications to be transmitted or received through the wireless digital data interface.

2. The headset flash memory drive of claim 1, wherein the flash memory chip comprises a NAND flash memory chip dedicated to mass storage.

3. The headset flash memory drive of claim 1, wherein the flash memory chip comprises on the order of approximately 1 gigabyte or greater of memory.

4. The headset flash memory drive of claim 1, wherein the wireless digital data interface comprises an IEEE 802.11 transceiver.

5. The headset flash memory drive of claim 1, wherein the wireless digital data interface comprises a Bluetooth transceiver.

6. A headset flash memory drive comprising:
a headset housing;
a microphone;
a speaker;
a flash memory chip for data storage;
a wired digital data interface connector comprising a mini-USB connector;
a controller; and
a computer readable memory storing first instructions for a mass storage access protocol that when executed by the controller allow data transfer to and from the flash memory chip through the wired digital data interface connector, and storing second instructions that when executed by the controller allow the microphone to detect user speech or the speaker to output an audio signal.

7. (canceled)

8. The headset flash memory drive of claim 7, wherein the mini-USB connector comprises a mini USB AB type receptacle.

9. (canceled)

10. The headset flash memory drive of claim 7, wherein the mini-USB connector comprises a mini A plug or mini B plug.

11. The headset flash memory drive of claim 6, wherein the mass storage access protocol comprises a USB mass storage device class communications protocol.

12. (canceled)

13. The headset flash memory drive of claim 6, wherein the flash memory chip comprises a NAND flash memory chip dedicated to mass storage.

14. The headset flash memory drive of claim 6, wherein the flash memory chip comprises on the order of approximately 1 gigabyte or greater of memory.

15. A headset flash memory drive comprising:
a headset housing;
a microphone;
a speaker;
a flash memory chip for data storage;
a wireless digital data interface comprising a wireless USB transceiver;
a controller; and
a computer readable memory storing first instructions for a mass storage access protocol that when executed by the controller allow data transfer to and from the flash memory chip through the wireless digital data interface, and storing second instructions that when executed by the controller allow the microphone to detect user speech or the speaker to output an audio signal.

16. (canceled)

17. (canceled)

18. (canceled)

19. The headset flash memory drive of claim 15, wherein the flash memory chip comprises a NAND flash memory chip dedicated to mass storage.

20. The headset flash memory drive of claim 15, wherein the flash memory chip comprises on the order of approximately 1 gigabyte of memory or greater.

21. (canceled)

22. A headset flash memory drive comprising:
a headset housing;
a microphone;
a speaker;
a rechargeable battery;
a flash memory means for mass data storage;
a wired digital interface connector means comprising a wired Ethernet connector means for transferring data to or from the flash memory means, transferring audio communications to the speaker or from the microphone, or transferring charging power to the rechargeable battery;
a wireless digital data interface for transferring data to or from the flash memory means, or transferring audio communications to the speaker or from the microphone;
a controller; and
a computer readable memory storing first instructions that when executed by the controller allow data transfer to or from the flash memory means through either the wired digital interface connector or the wireless digital data interface, and storing second instructions that when executed by the controller allow voice communications to be transmitted or received through the wired digital interface connector or the wireless digital data interface.

23. The headset flash memory drive of claim 22, wherein the flash memory means comprises on the order of approximately 1 gigabyte of memory or greater.
